(19) United States
(12) Patent Application Publication
(10) Pub. No.: US 2006/0076532 A1
(43) Pub. Date: Apr. 13, 2006

(54) Heat transmitting fluid and its respectuve obtaining process

(76) Inventor: Baldur Achim Offermann, Roetgen (DE)

Correspondence Address: Steinberg & Raskin, 1140 Avenue of the Americas, 15th floor, New York, NY, 10036-5803, US

(21) Appl. No.: 10/526,269

(22) PCT Filed: Jul. 16, 2003
(86) PCT No.: PCT/BR03/00099

§ 371 Date: Mar. 2, 2005

(30) Foreign Application Priority Data
Sep. 3, 2002 (BR) PI 0203527-8

(51) Int. Cl. C09K 5/04

(52) U.S. Cl. 252/67

(57) ABSTRACT

A non-toxic heat transmitting fluid, applicable to thermal oil systems in the food, pharmaceutical, cosmetic and chemical industry, which need heating without the use of flame or electrical resistance, to which original innovating functional disposition has been given. The heat transmitting fluid is different from other types of heat transmitting fluids usually found in the market, since it is composed of antioxidant based on derived phenyl and fluid based on polyintemalolefines PIO or polyalfaolefines PAO. The heat transmitting fluid is applied in application temperatures between −40 and 395° C., being that its specific application is of heat transmitting fluid totally synthetic, for thermal oil systems in the food, pharmaceutical, cosmetic and chemical industry.

The present invention refers to a revolutionary non-toxic heat transmitting fluid, applicable to thermal oil systems in the food, pharmaceutical, cosmetic and chemical industry, which need heating without the use of flame or electrical resistance, to which original innovating functional disposition has been given, being different from other types of heat transmitting fluids usually found in the market.

More concretely, the referred fluid is constituted of polyinternalolefines PIO or polyalfaolefines PAO and additives especially provided so as to conceive a heat transmitting fluid with density, viscosity and other thermal properties suitable for the function its used for.

There is, therefore, in the referred patent application, a heat transmitting fluid especially elaborated and developed to obtain enormous easiness and which offers big advantages, in both, in its manufacturing as well as in its application, since it does not require specific knowledge in addition to the traditional already existing experience in the chemical industry and of petroleum by-products.

It is yet, objective of the present application, to present a heat transmitting fluid with suitable costs for its industrial feasibility, however allied to the functionality requirements and usefulness easiness, offering this way to the public an additional option in the similar market with large acceptance in the technical area, user of this product.

As its is known in the industrial-technical field, for the manufacturing of several products, there is the need of steps which involve heat to carry out the transformation of its internal molecular structure

For that, the equipment, which performs such transformations, has heat constructive dispositions, which comply with the safety and economy requirements of a more feasible process.

In a general way, the industrial heat devices are applied directly to the equipment, through electrical resistance or by burners fed with liquid or gas fuel, since it offers a larger performance and lower loss by thermal dissipation, however, it is not always possible to apply the heating by the above mentioned devices, because of dangerous situations such as the presence of highly inflammable material such as volatile and organic solvents, polymers, cellulose, paints, among others, which can get fire with the least contact with short-circuits or flame.

In these cases, found mainly in the food, pharmaceutical, cosmetics and chemical industries, the equipment is heat indirectly using water steam or heat transmitting oils, which are heat by means of suitable boilers, being the hot liquid sent through piping provided with thermal insulation up to the mentioned industrial equipment, which is heat by means of hot fluid circulation within coils displaced around or within the contact device with the product to be transformed, being that the fluid, after transmitting heat, returns to the boiler to be heat and reused.

These heating dispositions are useful in the industrial process point of view to what it is destined to, however, they have some drawbacks in the safety and maintenance point of view.

The heating by means of water steam has the inconvenient when the water condensation takes place in the water transport ducts forcing the users to use this kind of heating to install purge system along the whole steam line, to extract such condensed water. The presence of condensed water in the piping provokes the formation of internal cavitation, causing the piping undesirable vibration, in addition that the water accumulated in the piping also favors the formation of corrosion products exposing the system to serious risks of clogging, degradation of tubular installations and consequent explosions.

In case of using heat transmitting oil, there is the toxic inconvenient, since most of the fluids used in the indirect heating systems are toxic.

Another important fact to be pointed out is that the systems which use these transmitting fluids usually are subject to leakage, exposing the fluid to the industrial environment, contaminating the operational which is in constant contact with them, or by direct contact or by steam aspirations.

The danger caused by these heat transmitting oils is known by the technical-scientific field, which has studies which define the component “biphenyl”, used in most of the thermal oil available in the world market, as being carcinogenic and harmful to the central nervous system, therefore, extremely harmful to the operators and products subject to contamination, when being manufactured.

Another important factor is that thermal oils are subject to leakage in its connections, flanges and rotating joints, situations in which an operator's contact or even the contact of food, pharmaceutical or cosmetic products under manufacturing process is inevitable.

Therefore, owing to these facts and from the development which has occurred in the last decades in the organic composed science, allied to the worry of process optimization, the present “HEAT TRANSMITTING FLUID AND ITS RESPECTIVE OBTAINING PROCESS” has been developed, being better presented in two topics, as follows:

### Heat Transmitting Fluid Composition

The heat transmitting fluid composition, expressed in percentage (%), in weight, in relation to the product total weight is the following:
Anti-oxidant, preferentially derived phenyl or equivalent, being added in the fluid between 0.1 and 0.5%, in mass;
Basic fluid, polyinternalolefines PIO or polyalfaolefines PAO being added in the fluid between 99.5 and 99.9%, in mass;

Heat Transmitting Fluid Manufacturing Process

The process or, more specifically, the procedure for the obtaining of heat transmitting fluid consists of the following steps:

1) Weighting of reagents used in the heat transmitting fluid preparation, using a duly gauged scale;

2) Homogenization of polyinternalolefine or polyalphaolefine with the help of suitable mechanical shakers suitable for low viscosity, preferentially with medium speed and enough capacity to contain all reagents to be used for the manufacturing of fluid and provided with heating system for work between room temperature and up to 70° C., during the homogenization;

3) Addition of antioxidant in the container mentioned in item 2, under continuous shaking;

4) Mixture and homogenization after the addition of antioxidant, being the mixing time defined according to the practice, until a homogeneous mixture is obtained. After the mixture, the heat transmitting fluid is placed in suitable containers.

Thus, it should be understood that the referred product is extremely simple in its formulation, showing, therefore, easy feasibility and supplying excellent practical and functional results on the known heat transmitting fluids.

The heat transmitting fluid now proposed can be used in application temperatures between −40 and 395° C., being that its specific application is of heat transmitting fluid totally synthetic, for thermal oil systems in the food, pharmaceutical, cosmetic and chemical industry.

In addition to that, being its base of synthetic hydrocarbon, it has properties such as: cinematic viscosity of 20 mm²/s at 40° C. according to DIN 51562, thermal dilation coefficient around 0.009/° K, steam pressure at 150° C. around 0.1 mbar and Conradson Charcoal waste around 0.01% in weight.

Such transmitting fluid is considered non-toxic and complies with the requirements of legal departments on the subject, in addition, it refer to a thermal transmitting fluid with superior transmitting capacity, also granting protection against corrosion and excellent stability to high and low temperatures, being suitable to be used in closed circuits, being that with specific characteristics, as mentioned above, they allow a safe operation of thermal oil systems, usually, subject to leakages in its connections, flanges and rotating joints, situations in which an operator's contact or even the contact of food, pharmaceutical or cosmetic products under production process is inevitable.

The fluid, when in the presence of inert gas allows significant increase of its operation period, not presenting any incompatibility with heating and cooling materials usually used, such as steel, cast iron and stainless steel, and it neither changes its color nor reduces the service time when using copper brass, bronze or aluminum.

It can this way be verified through what has been previously said that the “HEAT TRANSMITTING FLUID AND ITS RESPECTIVE OBTAINING PROCESS” now referred, is characterized as a product of great use, presenting all practical and functional qualities which fully justify the Invention Privilege application, since it plays the proposed role of non-toxic heat transmitting fluid, to be used as thermal oil in the food, pharmaceutical, cosmetic and chemical industry.

The product is also highlighted by the versatility of its industrial scale manufacturing, from the raw-materials mixture.

While the present application was illustrated and described regarding the above intended modality, it will be apparent to those acquainted with that technique that other modifications in the process composition and details can be done here without moving away from spirit and scope of what has been applied, as it is well defined in the enclosed claim.

1. HEAT TRANSMITTING FLUID AND ITS RESPECTIVE OBTAINING PROCESS wherein the heat transmitting fluid composition, Express in percentage (%), in weight, in relation to the product total weight, as follows: antioxidant, preferentially derived phenyl or equivalent, being added in the fluid between 0.1 and 0.5%, in mass—basic fluid, polyinternalolefines PIO or polyalfaolefines PAO being added in the fluid between 99.5 and 99.9%, in mass.

2. HEAT TRANSMITTING FLUID AND ITS RESPECTIVE OBTAINING PROCESS wherein the procedure for the obtaining of heat transmitting fluid comprises:
1) weighing of reagents used in the heat transmitting fluid preparation, using a suitable gauged scale;
2) homogenizing the heat transmitting fluid with the help of mechanical shakers suitable for low viscosity, preferentially with medium speed and constructively suitable to operate with synthetic hydrocarbon, enough capacity to contain all reagents to be used for the manufacturing of fluid and provided with heating system for work between room temperature and up to 70° C., during the homogenization;
3) adding an antioxidant to the mechanical shaker, under continuous shaking;
4) mixing and homogenizing the heat transmitting fluid after the addition of the antioxidant, being the mixing time defined according to the practice, until an homogeneous mixture is obtained, being that after the mixture, the heat transmitting fluid is placed in metal containers.
